(19) United States
(12) Patent Application Publication
(10) Pub. No.: US 2026/0225247 A1
(43) Pub. Date: Aug. 6, 2026

(54) Methods and Systems for Robot Coordination

(71) Applicant: Ofinno, LLC, Reston, VA (US)

(72) Inventors: Sina DINAN, McLean, VA (US); Karim TAMIM, Fairfax, VA (US); Aaron HERMANOFF, Fairfax, VA (US); Lucas TRACZYNSKI, Fairfax, VA (US); Cole WEEMS, Fairfax, VA (US); Darian FARAHANI, Herndon, VA (US); James SENNOTT, Fairfax, VA (US)

(21) Appl. No.: 19/636,799

(22) Filed: Apr. 1, 2026

(51) Int. Cl. B25J 9/16; B25J 5/00

(52) U.S. Cl. CPC B25J 9/1682; B25J 5/007; B25J 9/1612; B25J 9/1697

(57) ABSTRACT

A robotic system and method for coordinating multi-robot teams to optimize object manipulation and sequence-based scoring in a dynamic environment. The system comprises robots equipped with mobility systems, articulable arms, and processing circuitry. The processing circuitry tracks the number and color of objects projected toward a specified goal location and evaluates the objects against a desired target sequence. Utilizing historical performance ratios, real-time score tracking, and dynamic threshold monitoring tied to a countdown timer, the system dynamically switches the robots between a non-collaboration mode and a collaborative mode. Within the collaborative mode, robots are selectively assigned to distinct operational states, as a dynamic state for both collecting and projecting, and a throw state for exclusively projecting, based on historical projection accuracy. The system continuously evaluates real-time performance and localized object color distributions to dynamically swap robot states and maximize sequence adherence.

### FIELD

The present disclosure generally relates to robotic systems and control systems, and more particularly, to systems, methods, and apparatuses for multi-robot coordination and strategic control in dynamic environments.

### BACKGROUND

Advances in robotics and automation have led to the development of autonomous and semi-autonomous mechanical robots capable of performing increasingly complex operations. In many applications, robots are deployed in dynamic environments to perform object manipulation tasks, such as acquiring, tracking, and maneuvering objects toward a specific location. For example, in competitive robotics, sports applications, or dynamic industrial sorting, robots may be programmed to execute a sequence of actions to project or place objects, such as balls, into specified goal locations to achieve a score or fulfill a task metric.

While individual robots can be engineered to execute these tasks with high precision, the performance of a single robot is inherently constrained by physical limitations, such as kinematics, payload capacity, cycle time, distance to target, and line-of-sight constraints. Furthermore, in environments where multiple robots operate simultaneously, existing control schemes often treat each robot as an isolated agent. These robots typically execute independent routines or react to their environment locally without high-level strategic synchronization.

When multiple robots attempt to complete a shared objective or operate within the same physical space, a lack of active coordination can lead to inefficiencies, spatial interference, and sub-optimal task execution. Consequently, the combined output of the robots falls short of the optimal performance that could be achieved. Therefore, there remains a significant need in the art for improved systems and methods that enable strategic coordination between multiple robots to optimize overall performance and achieve shared objectives in dynamic, task-based environments.

### SUMMARY OF EXAMPLE EMBODIMENTS

According to an embodiment, a robotic system is provided. The system comprises a first robot assigned to a team. The first robot comprises: a mobility system including a first motor and a plurality of wheels; an articulable arm configured to grasp and project objects toward a specified goal location; a power source; a memory storing a point-allocation system, a desired sequence of objects, and a collaboration algorithm; and processing circuitry operatively coupled to the memory, the mobility system, the articulable arm, and the power source. The processing circuitry is configured to: track a number of objects projected by the articulable arm toward the specified goal location; determine a color associated with each of the projected objects; calculate a score based on the point-allocation system corresponding to the tracked number and the determined color of the projected objects; execute the collaboration algorithm to evaluate the tracked number and the determined color of the projected objects against the desired sequence of objects; and dynamically switch the first robot between a non-collaboration mode and a collaboration mode with at least a second robot of the team based on the evaluation.

According to an embodiment, a method for coordinating robots is provided. The method comprises: operating a first robot of a robot team in a non-collaboration mode, the first robot comprising processing circuitry, a mobility system, and an articulable arm; projecting, via the articulable arm, one or more objects toward a specified goal location; tracking, by the processing circuitry, a number of the projected objects and a color associated with each of the projected objects; evaluating, by the processing circuitry, the tracked number and the color of the projected objects against a desired sequence of objects; and dynamically switching the first robot from the non-collaboration mode to a collaboration mode with a second robot of the robot team based on the evaluation satisfying a threshold condition of the desired sequence.

According to an embodiment, a non-transitory computer readable storage medium is provided. The storage medium has stored therein program instructions that, when executed by a processing circuitry of a first robot of a robot team comprising at least the first robot and a second robot, causes the first robot to perform operations comprising: operating the first robot in a non-collaboration mode, the first robot comprising processing circuitry, a mobility system, and an articulable arm; projecting, via the articulable arm, one or more objects toward a specified goal location; tracking, by the processing circuitry, a number of the projected objects and a color associated with each of the projected objects; evaluating, by the processing circuitry, the tracked number and the color of the projected objects against a desired sequence of objects; and dynamically switching the first robot from the non-collaboration mode to a collaboration mode with the second robot of the robot team based on the evaluation satisfying a threshold condition of the desired sequence.

### BRIEF DESCRIPTION OF THE DRAWINGS

Some features are shown by way of example, and not by limitation, in the accompanying drawings. In the drawings, like numerals may reference similar elements.

FIG. 1 shows an example operational arena in which at least two robots configured according to some embodiments, can operate to perform a specified task or set of tasks.

FIGS. 2A-2F show aspects of the hardware and software configuration of a robot, according to some embodiments of this disclosure.

FIGS. 3A and 3B show a robot team operating in a collaboration mode and a non-collaboration mode, respectively, according to some embodiments of this disclosure.

FIG. 4 shows a flowchart of a process for dynamically adapting an operational mode of one or more robots of a robot team, according to some embodiments of this disclosure.

FIG. 5 shows a flowchart of a process for dynamically switching an operational state of one or more robots operating in the collaboration mode, according to some embodiments.

FIGS. 6 and 7 show flowcharts of processes for adapting the object collection process while performing a task, according to some embodiments.

FIGS. 8 and 9 show flowchart of processes for adapting a robot's operation in special situations in a dynamic operational environment, according to some embodiments.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In an exemplary embodiment, the robotic system is deployed within a bounded operational arena (e.g., a 12-foot square playing field). The system architecture supports a multi-robot competitive environment comprising a plurality of robot entities. For example, the arena may host four independently controlled robots divided into two opposing alliances (e.g., a red alliance and a blue alliance), wherein two randomly selected teams are paired per alliance. To ensure standardized spatial operation, each robot may be constrained to a predetermined initial dimensional envelope, such as fitting within an 18-inch volumetric sizing cube prior to the initiation of an operational period. Because all allied and opposing robots operate within a shared physical space and compete for a shared set of resources (e.g., projection objects), the environment is highly dynamic, and robot-to-robot physical interactions—such as cooperative positioning, and spatial interference—may be anticipated and factored into the collaboration algorithm.

The shared resources comprise a finite plurality of maneuverable objects (projection objects) having visually distinct characteristics. In one specific implementation, the objects include game artifacts of a first type (e.g., 24 purple artifacts) and a second type (e.g., 12 green artifacts). In this embodiment, the robots are mechanically restricted from autonomously elevating and collecting objects directly from the arena surface. Instead, a robot utilizes its mobility system and a forward manipulator assembly to laterally translate (e.g., push or sweep) the scattered objects toward a designated staging area or loading zone. A human operator positioned adjacent to the loading zone acts as a collaborative intermediary, manually transferring the objects from the loading zone into a payload receptacle (e.g., a hopper) disposed on the robot. The payload receptacle is physically configured to retain a predetermined maximum batch size (e.g., a capacity of up to three artifacts) at any given time.

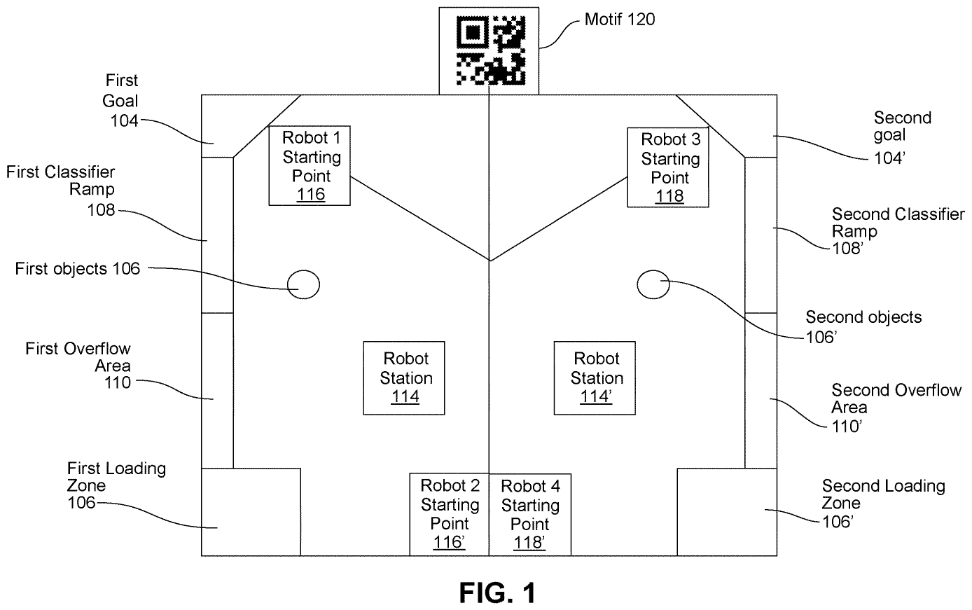

FIG. 1 shows an example of an operational arena 102, according to some embodiments. The example operational arena 102 comprises two goals 104 and 104′, two loading zones 106 and 106′, two classifier ramps 108 and 108′, and two overflow areas 110 and 110′. The operational arena 102 accommodates two robot teams and projection objects of two colors. The initial (starting) configuration may comprise locating all the projection objects of the first color in a first object area 112 and all the projection objects of the second color in a second object area 112′. Robot base locations 114 and 114′ may be designated for the first robot team and the second robot team, respectively. Designated starting locations 116, 116′, 118, and 118′ may be specified for the first robot, the second robot, the third robot and the fourth robot, respectively.

Prior to or upon initiation of an operational period, the robotic system determines a desired sequence (e.g., a target color order or “motif”) for object placement. The desired sequence may be dynamically assigned via a machine-readable optical label, such as a QR code, located within the environment and decoded by an onboard sensor of the robot. An example machine-readable optical label 120 located within or adjacently to the operational arena 102 is shown in FIG. 1. For example, the optical code 120 may be affixed to a wall at the perimeter of the arena 102 or may be affixed to the floor of the arena, in a manner that can be read using an image sensor, such as a camera or infrared sensor, by a robot.

To accumulate a score, robots navigate to specified goal locations comprising at least a primary scoring region (e.g., a classifying ramp) and a secondary scoring region (e.g., an overflow area) that is adjacent to the primary scoring area. The point-allocation system stored in memory is configured to award a first point value for objects deposited in the primary scoring region and a lower, second point value for objects deposited in the secondary region.

In some embodiments, the point-allocation system executes a batch-processing algorithm for objects deposited into the primary scoring region (the classifying ramp). The processing circuitry logically partitions the physical sequence of deposited objects, starting from a baseline origin (e.g., a mechanical gate), into discrete sequential subsets of a predetermined integer (e.g., subsets of three artifacts). A localized sub-score is calculated for each discrete subset based on its color composition. Furthermore, the processing circuitry evaluates the physical order of the subset against the decoded motif. If a subset matches the desired sequence defined by the motif, the system applies a predetermined bonus to the sub-score. The total ramp score is generated by aggregating these subset sub-scores.

The processing circuitry controls the robots across distinct temporal phases of an operational period: a first autonomous phase, a second teleoperated phase, and third terminal phase.

During an initial period (e.g., the first 30 seconds), referred to herein as the “first autonomous phase”, the robots operate strictly via autonomous control logic. Actions performed during this phase include decoding the machine-readable optical code (e.g., QR code) to determine the motif, exiting a starting location, and autonomously projecting (i.e. to score) initially staged objects into the specified goal locations.

During a subsequent, intermediate period (e.g., the following two minutes), referred to herein as the “second teleoperated phase”, the system transitions to a semi-autonomous or fully teleoperated mode. Human drivers provide navigational inputs to the robots, directing them to push objects to the loading zone, receive objects from human players, open classifying gates, and execute scoring maneuvers based on the decoded motif.

During a final period (e.g., the last 20 seconds), referred to herein as the “third terminal phase”, the collaboration algorithm dynamically evaluates the current score, the remaining time, and the spatial position of the allied second robot. The system determines whether a robot should continue attempting to score artifacts or navigate to a designated terminal zone (e.g., a home base). A system-level rule dictates that if both the first robot and the second robot of an alliance successfully occupy the terminal zone prior to the expiration of the third phase, a point bonus is awarded to the alliance.

In various embodiments, the mobility system of the first robot comprises a first motor and a plurality of wheels (e.g., omni-directional wheels, or continuous tracks) configured to navigate the operational arena. To manipulate objects within the environment, the first robot includes an articulable arm. As used herein, the “articulable arm” may comprise any multi-axis robotic manipulator, pneumatic actuator, or mechanical appendage configured to physically interact with the objects. In a preferred embodiment, the articulable arm is configured to dynamically grasp and project (e.g., throw, launch, or shoot) objects toward a specified goal location. To facilitate autonomous targeting and color identification, the first robot further comprises an optical sensor (or other type of sensor) disposed directly on the articulable arm, or alternatively on a chassis of the robot. The optical sensor (e.g., an RGB camera, infrared sensor, or LiDAR) is configured to capture image data of the objects. The processing circuitry processes this captured image data to determine the color associated with each of the projected objects.

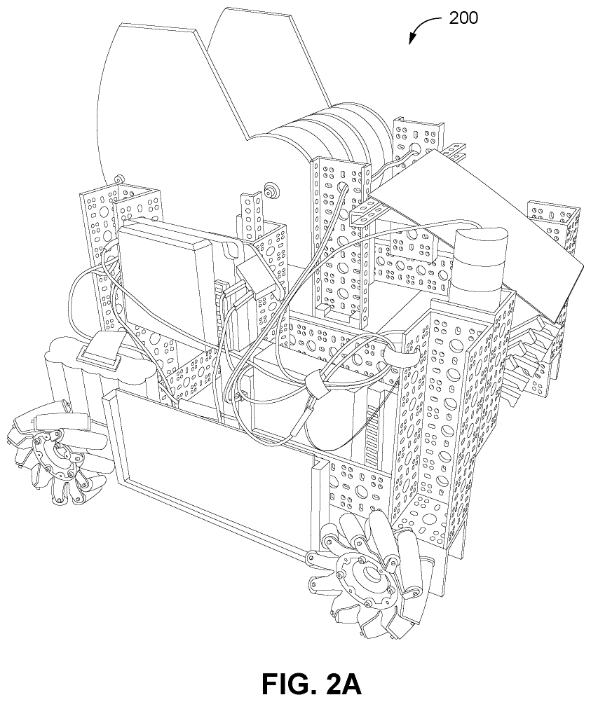

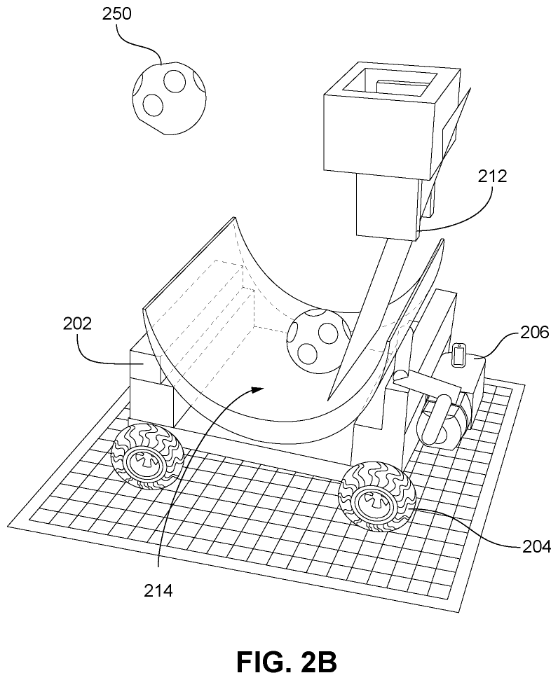

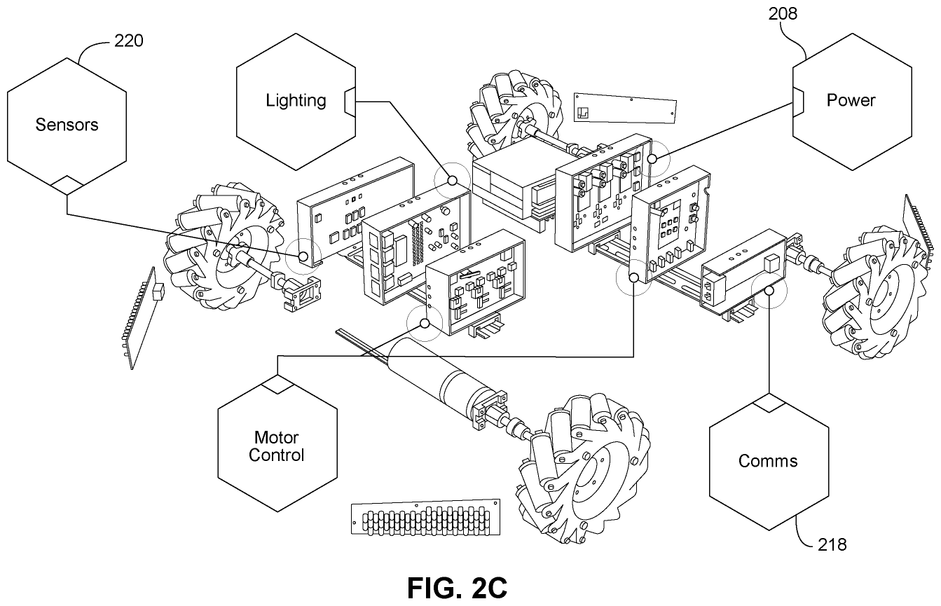

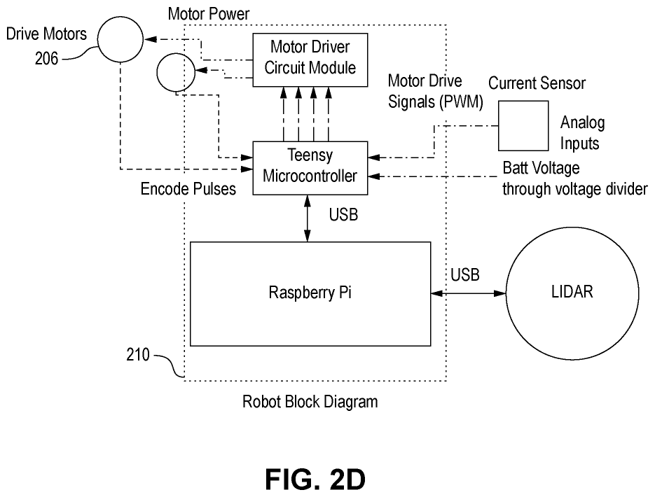

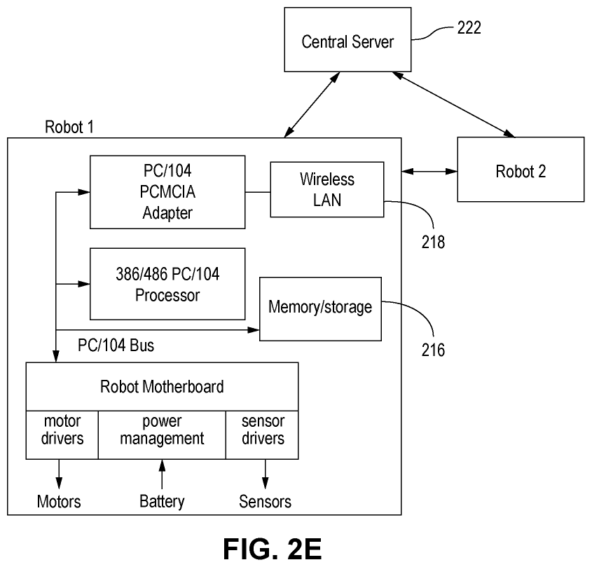

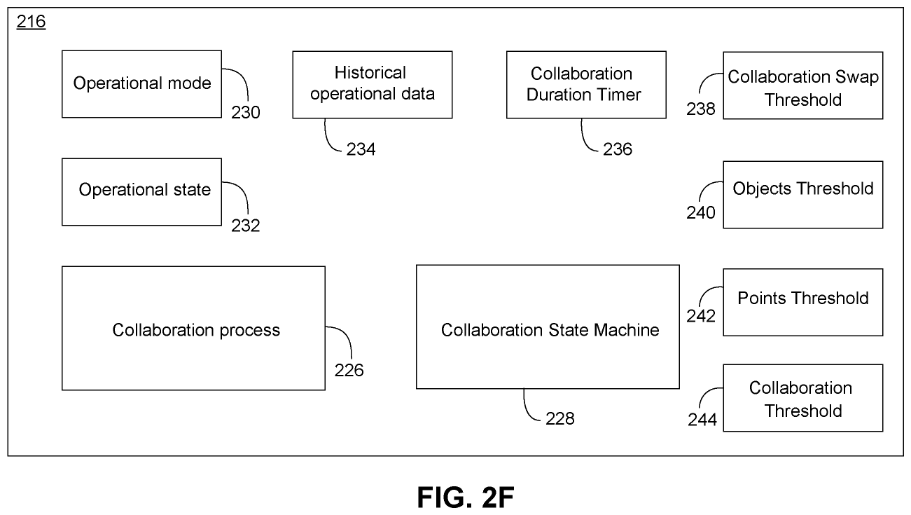

An example robot 200 is shown in FIG. 2A and a schematic illustration of an example robot is provided in FIG. 2B. As described above, each robot according to embodiments of this disclosure includes a chassis 202, wheels 204, motors 206, one or more power sources 208, processing circuitry 210, an articulable arm 212 and an object collection area 214. An example projection object (or simply, “object”) 250, such as, for example, a ball, that may be collected in the objection collection area 214 of the robot and be gripped by the articulable arm 212 before being projected (launched) by the robot towards a goal to score points.

In an exemplary embodiment, the robot utilizes a multi-tiered hardware architecture to separate high-level collaborative processing from real-time electromechanical control. The processing circuitry 210 of the robot may comprise a primary computing device (e.g., a Raspberry Pi, a PC/104 processor, or an equivalent x86/ARM-based single-board computer) communicatively coupled to a low-level microcontroller (e.g., a Teensy microcontroller or dedicated robot motherboard). The primary computing device includes a solid-state disk 216 or equivalent memory for storing the point-allocation system, the collaboration algorithm, and high-level operating logic. The primary computing device interfaces with the microcontroller via an internal communication bus, such as a Universal Serial Bus (USB) connection or a PC/104 Bus.

The mobility system of the robot includes a plurality of wheels. As illustrated in the exemplary embodiments, the mobility system may comprise a four-wheel independent drive base utilizing omnidirectional (or mecanum) wheels, enabling holonomic motion within the operational arena. Each wheel is driven by a dedicated drive motor. Real-time control of the mobility system is controlled by the microcontroller, which generates motor drive signals (e.g., Pulse Width Modulation (PWM) signals) transmitted to a motor driver circuit module. To form a closed-loop control system, the drive motors are equipped with rotary encoders that transmit encoder pulses back to the microcontroller, allowing for precise odometry, speed regulation, and positional tracking.

To navigate the dynamic environment and identify the objects, the first robot includes a one or more sensors 220. High-bandwidth environmental sensors, such as a Light Detection and Ranging (LiDAR) module, are connected directly to the primary computing device via a USB or equivalent high-speed interface to enable spatial mapping and obstacle avoidance. The robot further includes a plurality of analog and digital sensors routed to the microcontroller. These may include current sensors to monitor motor load (e.g., detecting if the robot is pushing against a heavy object or an opposing robot) and optical sensors or lighting modules to aid in the visual identification of the colored artifacts.

The robot includes an onboard power source (e.g., a battery pack) 208 coupled to a power management module. The power management module distributes appropriate operating voltages to the primary computing device, the microcontroller, and the motor drivers. The microcontroller continuously monitors the health and capacity of the power source via analog inputs, such as receiving a battery voltage signal through a voltage divider circuit. This allows the processing circuitry to factor battery life into the collaboration algorithm (e.g., swapping a robot with low battery to the stationary “throw state”).

To enable the collaboration mode and transmit trajectory or state-swap data, the first robot features a robust communication system 218. The primary computing device is coupled to a network adapter, such as a PCMCIA adapter and a Wireless Local Area Network (LAN) module. Through this wireless LAN, the first robot establishes a direct or mesh communication link with the second robot of the robot team. Furthermore, the wireless LAN allows the first robot to communicate with a Central Server 222, which may control the overarching operational period timer, broadcast the QR code motif data, or record the total accumulated points for the allied team. In some examples, each robot tracks its own metrics (e.g., objects collected, objects projected, operational mode, operation state, etc.) and also its determination of the totals (e.g., total score based on objects in the classifier ramp and the overflow ramp) to the central server, and the central server performs the calculations for the robot teams and transmits the relevant updated thresholds and other control instructions to each robot in the team. In some examples, each robot determines its own metrics and exchanges (e.g., other the communication link) the determined metrics as needed with the other robot in its team.

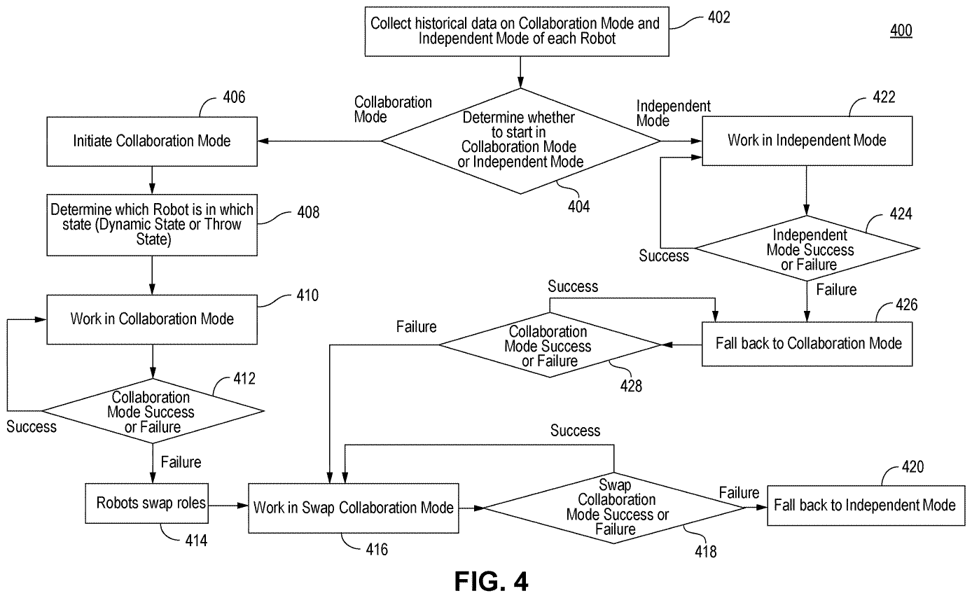

FIG. 2F shows an example runtime view of an aspect of the memory 216 or other storage according to some embodiments. The memory 216 may include the instructions 226 executing the collaboration process as described in relation to FIGS. 4-9. The state machine 228 maintains the operational mode and the operational state of the robot in a reliable manner during runtime. The state machine 228 implements the transitions between the modes (e.g., collaboration mode, independent mode, and the transitional swap collaboration mode) and the transitions between the operational states (e.g., dynamic state and the throw state), and is further described in relation to FIGS. 4-9. In some embodiments the state machine is implemented in hardware to enable faster recovery of team coordination when a robot recovers from a failure (e.g., a power failure). The memory 216 may also store the operational mode 230, the operational state 232, historical operational data 234, the collaboration duration timer 236, the collaboration swap threshold 238, the objects threshold 240, the points threshold 242, and the collaboration threshold 244.

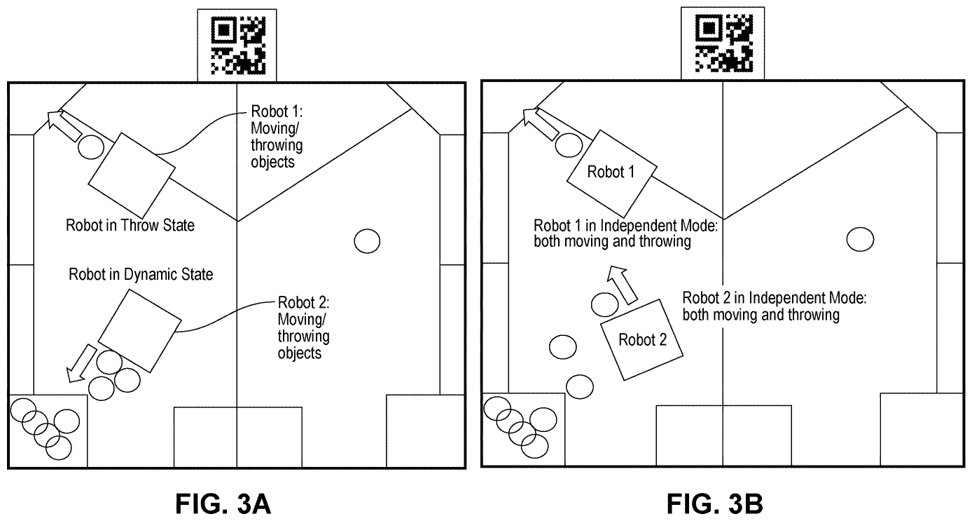

In example embodiments, the processing circuitry controls the robot by dynamically switching between a non-collaboration mode (e.g., an independent operational mode) and a collaboration mode. Within the collaboration mode, the processing circuitry may assign specific operational states to divide labor between the robot team. For example, operating the team in the collaboration mode may comprise assigning the first robot to a “dynamic state” and assigning the second robot to a “throw state.” The dynamic state configures a robot to perform both the tasks of translating (e.g., moving, pushing, or sweeping) objects to a loading zone and projecting objects toward the specified goal location. Conversely, the throw state configures a robot to exclusively project objects toward the specified goal location, thereby acting as a dedicated scoring robot. In example embodiments, the robot may dynamically update its current operational mode and its current operational state in a memory (e.g., memory locations 230 and 232, respectively) and/or a hardware register, during operation. FIG. 3A shows an example arena with the two robots of the first team in collaboration mode in which the first robot is operating in the throw state and the second robot is operating in the dynamic state. FIG. 3B shows an example arena with the two robots of the first team operating in the independent mode with each robot performing both actions: collecting and throwing.

Prior to initiating an operational period (e.g., a time period in which one or more game or task is performed), the system may execute an initialization routine to intelligently determine the starting mode. This routine relies on historical operational data. Specifically, the processing circuitry calculates a first collaboration ratio for the first robot based on a number of historical operational periods concluded in the collaboration mode relative to a number of historical operational periods concluded in the non-collaboration mode. A second, similar ratio is calculated for the second robot. The processing circuitry then calculates a mathematical product of the first ratio and the second ratio. If the calculated product is less than a predetermined collaboration mode threshold, the system initiates the robot team in the non-collaboration (independent) mode. Conversely, if the calculated product exceeds the predetermined threshold, the team is initiated in the collaboration mode.

Upon initiating the collaboration mode, the system determines which robot assumes the dynamic state and which assumes the throw state based on performance metrics. The processing circuitry retrieves a first historical projection accuracy metric for the first robot and a second historical projection accuracy metric for the second robot. By comparing these metrics, the processing circuitry automatically assigns the robot with the higher accuracy (e.g., the second robot, if its metric is greater) to the dedicated throw state to maximize scoring efficiency. The robot with the lower accuracy (e.g., the first robot) is subsequently assigned to the dynamic state.

While operating in the collaboration mode, the robots actively share data and alter physical maneuvers. In some embodiments, the processing circuitry of the first robot transmits a communication signal to the second robot comprising spatial data, such as the calculated trajectory data of the articulable arm and a specific target location for a subsequent object needed to fulfill the desired sequence. Furthermore, the collaboration algorithm may dictate defensive and delegatory actions. For instance, upon evaluating the tracked objects and determining that a requisite number of objects of a specific color have been successfully projected, the processing circuitry may trigger the collaboration mode to instruct the second robot to navigate to a defensive position adjacent to the goal location to prevent opponent interference. The first robot may communicate to the second robot, the number of objects projected by the first robot, score information determined by the first robot, etc. The first robot may also receive such communications from the second robot and update its internal metrics (scorekeeping) accordingly. Alternatively, the first robot may halt its own projection of objects having a first color and transmit an instruction to the second robot to initiate projection of objects having that first color.

Because competitive environments can be highly fluid, the collaboration algorithm includes a “swap collaboration mode” to dynamically reassign operational states mid-operation based on real-time performance. In an exemplary embodiment, upon entering the collaboration mode, the processing circuitry initializes and runs a collaboration duration timer (e.g., a countdown timer). The processing circuitry continuously monitors the total accumulated points and a “collaboration swap threshold” value. Crucially, this collaboration swap threshold is dynamically adjusted; for example, it may be dynamically incremented in accordance with the decrementing of the countdown timer. If the team is not scoring rapidly enough as time expires, the threshold rises to force a strategic shift.

The processing circuitry evaluates a collaboration state swap condition based on this continuous monitoring. If the condition is met (e.g., the threshold is breached), the processing circuitry dynamically swaps the first robot from the dynamic state to the throw state, or vice versa. Contemporaneously, the first robot signals the second robot to correspondingly swap its state. Following a successful swap, the processing circuitry may stop the collaboration duration timer and cease the threshold monitoring to allow the robots to settle into their newly assigned roles.

The collaboration state swap condition may be evaluated using specific point and object thresholds. For example, the processing circuitry tracks the total number of objects projected by the robot team. When this projected number equals or exceeds a predetermined object threshold, the system determines the total accumulated points for the team. If the accumulated points are less than a predetermined points threshold (e.g., indicating sub-optimal performance) while the first robot is operating in the collaboration mode, the processing circuitry automatically triggers the state swap between the dynamic state and the throw state.

To optimize the gathering of objects matching the desired sequence (e.g., a specific color motif), the collaboration algorithm utilizes a mathematical “k-factor.” The processing circuitry determines the k-factor based on the desired pattern of objects. During operation, the processing circuitry calculates a real-time, first ratio of collected objects having the first color (e.g., purple) to collected objects having the second color (e.g., green). The processing circuitry evaluates this first ratio against the determined k-factor. If the first ratio is less than or equal to the k-factor, the system dictates that the robot collect objects of the first color. Conversely, if the ratio exceeds the k-factor, the system dictates the collection of objects of the second color, ensuring the onboard payload maintains an optimal statistical distribution to fulfill the desired sequence.

FIG. 4 is a flowchart illustrating an exemplary method 400 for dynamically determining and managing operational modes of a robot team to perform a task in an optimal manner, according to some embodiments of this disclosure. The method 400 may be executed by the processing circuitry of one or more robots of the team, or in part by a centralized server communicatively coupled to one or more of the robots.

In some embodiments, the task performed by the robot team is a game (described above) in which each team must project objects of two different colors (or other distinguishing characteristic) to its goal to score points according to a predetermined desired pattern. As described above, a set of objects of a first color and a set of objects of a second color are maneuvered by two robot teams operating in an arena 102 to their respective goal areas to score points. For example, during an example operational period performing the task (e.g., a game), a first robot team (having the first and second robots) may collect objects from both (left and right halves) of the arena 102 but may score only on the goal in the left half of the arena, and a second robot team (having a third and fourth robot) may collect objects from both (left and right halves) of the arena but score only on the goal in the right half of the arena. The first robot team may comprise a first robot and a second robot, and the first robot may operate as described in relation to blocks 402-428.

The method 400 begins at step 402, where the processing circuitry collects historical data regarding the performance of each robot. This historical data includes historical performance metrics for both a collaboration mode and an independent mode (i.e., non-collaboration mode) for each robot. At step 404, the processing circuitry evaluates this historical data to determine whether to start the current operational period in the collaboration mode or the independent mode. This determination may be based, for example, on calculating and comparing the collaboration ratios of the first and second robots against a predetermined threshold, as previously described.

If the determination at step 404 is to initiate operations in the collaboration mode, the method advances to step 406 to initiate the collaboration mode. Subsequently, at step 408, the system determines which robot is assigned to which specific state within the collaboration mode. For instance, based on historical projection accuracy metrics, the processing circuitry assigns one robot to a dynamic state (collecting and projecting) and the allied robot to a throw state (exclusively projecting). At step 410, the robot team executes operations and works in the assigned collaboration mode.

During operation, the method proceeds to step 412 to continuously or periodically evaluate the success or failure of the collaboration mode. This evaluation may rely on the previously described collaboration duration timer, accumulated points, and dynamically incremented thresholds. If the evaluation indicates success (e.g., the team is meeting point thresholds), the method follows the “Success” path and loops back to step 410 to continue working in the current collaboration mode. Conversely, if the evaluation indicates a failure condition (e.g., sub-optimal scoring), the method follows the “Failure” path to step 414. At step 414, the processing circuitry commands the robots to swap roles (e.g., transitioning the first robot from the dynamic state to the throw state, and vice versa). At step 416, the team operates in this new “Swap Collaboration Mode.”

While operating in the swap collaboration mode, the system evaluates its success or failure at step 418. If successful, the method loops back to step 416 to maintain the swapped roles. However, if the swap collaboration mode also fails to meet performance thresholds, the method follows the “Failure” path to step 420. At step 420, the system triggers a complete fallback routine, forcing the robot team to abandon collaboration and fall back to working in the independent mode.

Returning to the initial decision at step 404, if the processing circuitry instead determines to start in the independent mode, the method advances directly to step 422, where both robots work in the independent mode (e.g., both operating in a dynamic state). At step 424, the system evaluates the success or failure of the independent mode based on real-time scoring data. If the independent mode is successful, the method loops back to step 422 to maintain independent operation.

If a failure condition is detected during independent operation at step 424, the method follows the “Failure” path to step 426, wherein the system forces a fallback into the collaboration mode. While operating in this fallback collaboration mode, the system evaluates its success or failure at step 428. If the fallback collaboration mode is successful, the method follows the “Success” path, looping back to step 426 to continue collaborative operations. However, if the fallback collaboration mode is deemed a failure at step 428, the method follows the “Failure” path, merging into step 416 to force the robots to operate in the swap collaboration mode.

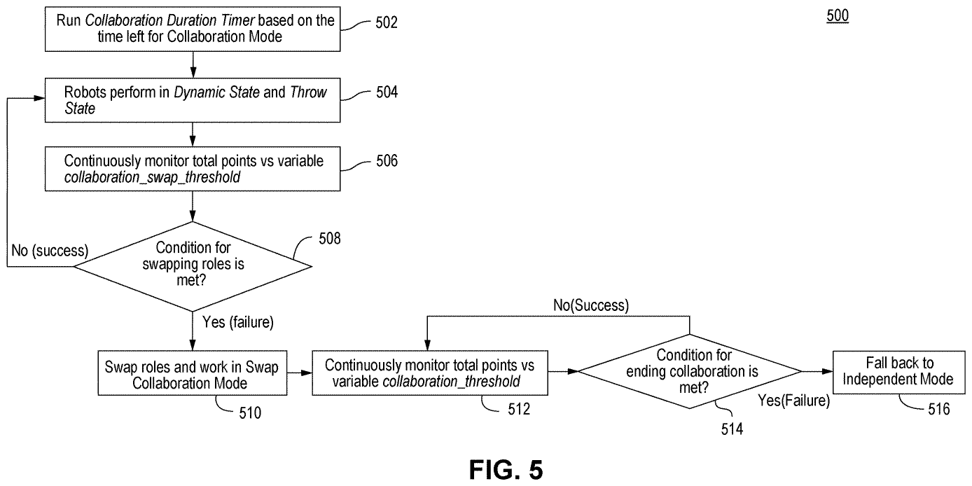

FIG. 5 is a flowchart illustrating an exemplary method 500, in collaboration with method 400 described above, for dynamically monitoring and swapping robot operational states during the collaboration mode. The method 500 expands upon the continuous evaluation logic utilized to maximize the team's scoring efficiency over a temporal period.

The method 500 begins at step 502, wherein the processing circuitry initializes and runs a “Collaboration Duration Timer”. This timer is based on the time remaining for the robot team to operate within the collaboration mode (e.g., a countdown timer tracking the remaining duration of a specific operational phase). At step 504, the robots perform operations in their initially assigned collaborative roles, wherein a first robot operates in a dynamic state (translating and projecting objects) and a second allied robot operates in a throw state (exclusively projecting objects).

While the robots execute these roles, the method proceeds to step 506. At step 506, the processing circuitry continuously monitors the total accumulated points generated by the robot team and compares this point value against a dynamically variable collaboration swap threshold (e.g., collaboration_swap_threshold). In an exemplary embodiment, this variable threshold is dynamically incremented in accordance with the decrementing of the collaboration duration timer, requiring the robots to score at a progressively higher rate to justify remaining in their current assigned states. In some embodiments, the collaboration swap threshold and a collaboration threshold (see step 512 below) are incremented as the collaboration duration timer is decremented. An illustrative example of the relationship between the collaboration duration timer, the collaboration swap threshold, and the collaboration threshold is shown in the table below:

| Collaboration Duration | Collaboration swap | Collaboration |
|---|---|---|
| Timer (remaining time) | threshold, points | threshold points |
| 1 min, 45 secs | 3 points | 6 points |
| 1 min, 30 secs | 5 points | 8 points |
| 1 min | 8 points | 10 points |
| 30 secs | 10 points | 13 points |

At decision step 508, the processing circuitry evaluates whether a predetermined condition for swapping roles is met. This condition is satisfied if the continuous monitoring at step 506 indicates a failure (e.g., the total accumulated points fall below the dynamically escalating collaboration_swap_threshold). If the condition is not met, indicating the current roles are successful and producing sufficient points, the method follows the “No” (i.e. success) path and loops back to step 504, allowing the robots to continue performing in their current dynamic and throw states.

If the evaluation at decision step 508 determines that the swapping condition is met, indicating sub-optimal performance, the method follows the “Yes” (i.e. fail) path to step 510. At step 510, the processing circuitry dynamically swaps the operational roles of the robots, effectively forcing the system to work in a swap collaboration mode. For example, the first robot is transitioned from the dynamic state to the throw state, and a communication signal is transmitted instructing the second robot to transition from the throw state to the dynamic state.

Following the role swap, the method advances to step 512, wherein the processing circuitry initiates a secondary continuous monitoring phase. Here, the system tracks the total points against a variable end-collaboration threshold (e.g., collaboration_threshold), which may be distinct from the initial swap threshold. The collaboration threshold was introduced above at step 506. As described, in some embodiments, the collaboration threshold may be incremented in accordance with the decrementing collaboration duration timer.

At decision step 514, the system evaluates whether a condition for ending the collaboration entirely is met (e.g., evaluating if the team continues to underperform despite the swapped roles). If the condition is not met, indicating the swap collaboration mode is successfully accumulating points, the method follows the “No” path and loops back to step 512 to continue monitoring the swapped configuration. However, if the condition for ending collaboration is met, the method follows the “Yes” path to step 516. At step 516, the system abandons the collaborative effort entirely and commands both robots to fall back to an independent mode (e.g., wherein both robots operate independently in the dynamic state).

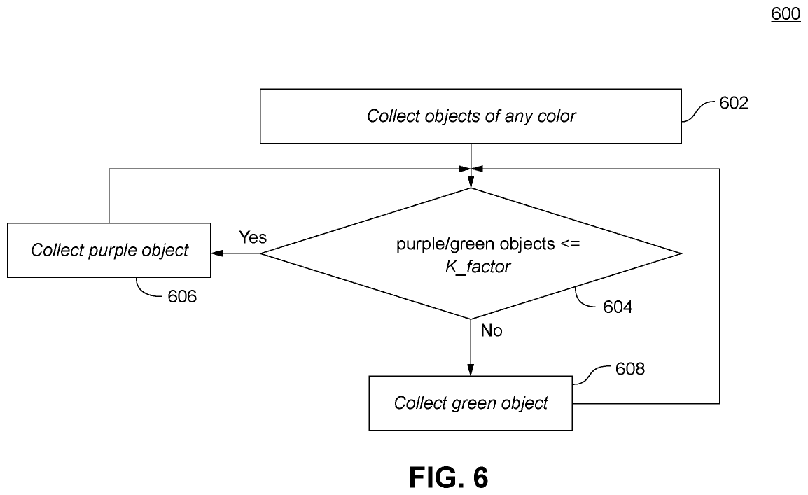

FIG. 6 is a flowchart illustrating an exemplary method 600, in collaboration with method 400 described above, for dynamically controlling the collection of objects based on a desired sequence or pattern. Method 600 may be executed by the processing circuitry of the first robot, the second robot, or both, while evaluating the tracked number and color of the projected objects against the desired sequence (e.g., the decoded motif). To optimize the payload for scoring, the processing circuitry utilizes a mathematical multiplier or target ratio, defined herein as a “K-factor”. The processing circuitry determines the specific value of the K-factor based on the desired pattern,

The method 600 begins at step 602, wherein the robot collects objects of any color. During this initial phase, the robot may sweep or intake available objects in the operational arena without color discrimination to establish a baseline payload. As the objects are collected, the processing circuitry tracks the quantity and color of the onboard objects. For example, the objects may comprise objects having a first color (e.g., purple) and objects having a second color (e.g., green).

Following the initial collection, the method advances to decision step 604. At step 604, the processing circuitry calculates a real-time ratio of the collected objects having the first color to the collected objects having the second color (e.g., calculating the ratio of purple objects to green objects). The processing circuitry then evaluates this calculated ratio against the predetermined K-factor to determine if the condition (purple/green objects <=K-factor) is satisfied.

If the calculated ratio is less than or equal to the K-factor, this indicates that the robot holds a deficit of the first color relative to the target sequence. Consequently, the condition at decision step 604 is satisfied, and the method follows the “Yes” path to step 606. At step 606, the processing circuitry commands the robot to specifically target and collect an object of the first color (e.g., collect a purple object). After collecting the purple object, the method loops back to the input of decision step 604 to recalculate the ratio and re-evaluate the payload distribution.

Conversely, if the calculated ratio at decision step 604 is greater than the K-factor, this indicates that the robot holds a sufficient quantity or surplus of the first color, and instead requires an object of the second color to maintain the optimal statistical distribution for the motif. In this scenario, the condition at decision step 604 is not satisfied, and the method follows the “No” path to step 608. At step 608, the processing circuitry commands the robot to specifically target and collect an object of the second color (e.g., collect a green object). Following the collection of the green object, the method loops back to decision step 604 to continuously monitor and adjust the collection strategy.

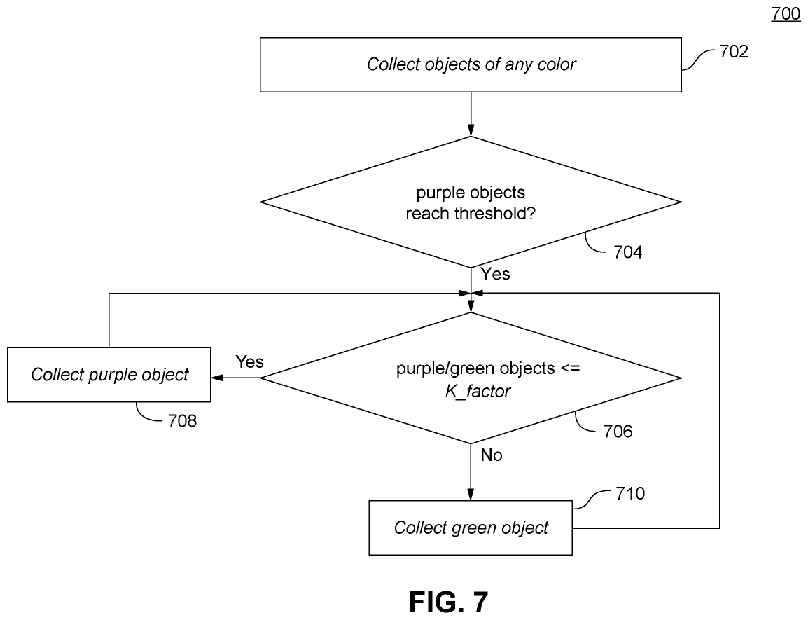

FIG. 7 is a flowchart illustrating an exemplary method 700 for dynamically controlling the collection of objects, representing an alternative or expanded embodiment of the K-factor logic. Method 700 introduces a gating threshold to ensure a baseline payload inventory of a primary object type is established before initiating ratio-based predictive collection.

The method 700 begins at step 702, wherein the robot executes an initial collection routine to collect objects of any color. During this phase, the robot navigates the operational arena and intakes available objects (e.g., objects having a first color, such as purple, and objects having a second color, such as green) without discriminating based on color.

As objects are collected, the method advances to decision step 703. At step 703, the processing circuitry evaluates the onboard payload to determine whether the quantity of collected objects of the first color (e.g., purple objects) has reached a predetermined baseline threshold. If the quantity of first color objects has not reached the threshold, the condition is not satisfied, and the method follows the “No” path, looping back to step 702 to continue the general collection of objects of any color.

Once the baseline threshold of first-color objects is achieved at decision step 704, the method follows the “Yes” path, transitioning into the K-factor predictive collection phase at decision step 706. At step 706, the processing circuitry calculates the real-time ratio of collected first-color objects to second-color objects (e.g., purple/green objects). The processing circuitry evaluates this calculated ratio against the predetermined K-factor to determine if the condition (purple/green objects <=K-factor) is satisfied.

If the calculated ratio is less than or equal to the K-factor at step 706, the method follows the “Yes” path to step 708. At step 708, the processing circuitry commands the robot to specifically target and collect an object of the first color (e.g., collect a purple object). After successful collection, the method loops directly back to decision step 706 to re-evaluate the ratio. Conversely, if the calculated ratio at step 706 exceeds the K-factor, the method follows the “No” path to step 710. At step 710, the processing circuitry commands the robot to specifically target and collect an object of the second color (e.g., collect a green object), subsequently looping back to decision step 706 to maintain continuous, dynamic payload optimization.

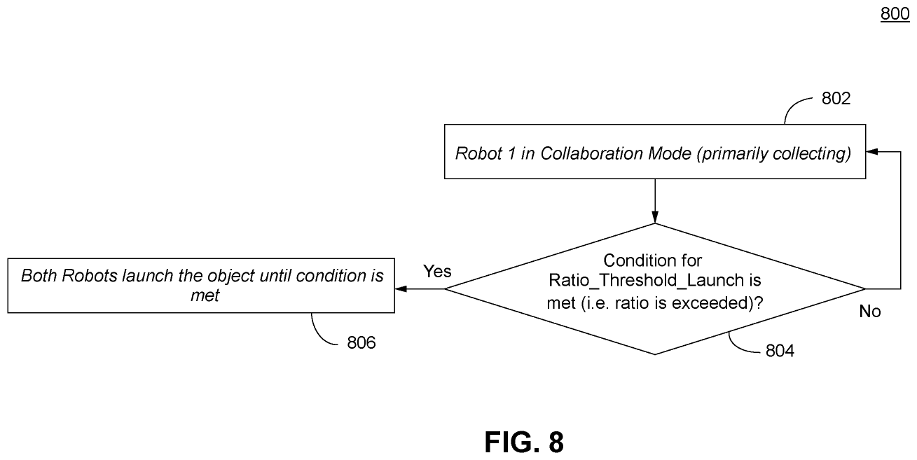

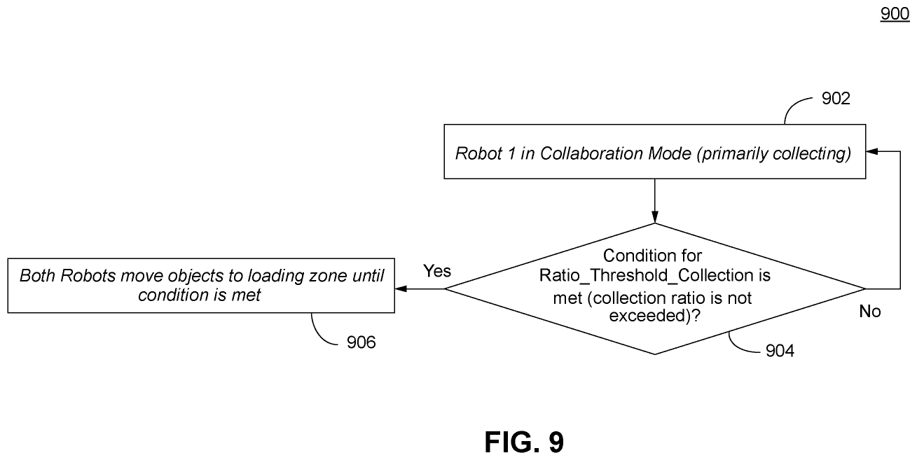

FIG. 8 and FIG. 9 illustrates processes by which a robot team may maintain an optimal amount of collected objects (e.g., objects moved to the loading zone) in relation to the number that is projected (launched) in order to ensure the number of points scored can be improved. According to some embodiments, one or both of a launch threshold and a collection threshold are predetermined. The two thresholds define different values for the ratio of the total number of objects collected to the total number of objects launched. Whereas it can be easily understood that the ratio should be one or greater so that the robot team is not prevented from continuing to project objects and improve its score, too large of an inventory of collected but unlaunched objects may mean many objects may never be launched (and therefore wasted effort) and too small of an inventory means that the team may run out of objects to launch (and therefore waste projecting capacity). The processes in FIG. 8 and FIG. 9 enable maintaining the inventory in an optimal range.

FIG. 8 is a flowchart illustrating an exemplary method 800 for dynamically transitioning a robot in a robot team operating in the dynamic state in collaboration mode, to a collaborative launching phase based on a threshold condition, according to some embodiments of this disclosure. Method 800 provides a control loop to improve the balance between the number of objects collected and the number of object launched for the robot team.

The method 800 begins at step 802, wherein a first robot (e.g., Robot 1) operates in the collaboration mode and is collecting objects (e.g., balls). For example, the first robot may be operating in the collaboration mode and in the dynamic state. During this step, the first robot utilizes its mobility system and manipulator assembly to push or otherwise move objects from various locations in the arena to its team's designated loading zone. While the first robot is actively collecting, the second robot in its team (e.g., Robot 2 or second robot) may be projecting objects. For example, the second robot is operating in the collaboration mode and in the throw state.

As the first robot collects objects, the method advances to decision step 804. At step 804, the processing circuitry evaluates a dynamic threshold condition, designated as the launch threshold (ratio_threshold_launch) condition. This condition may represent a calculated metric, such as reaching an optimal ratio of projected objects to collected objects.

If the processing circuitry determines that the condition for the launch threshold is not met (e.g., indicating that there is not too much collected payload that is not yet launched), the method follows the “No” path. The method loops directly back to step 802, causing the first robot to continue actively collecting objects in the collaboration mode.

Conversely, if the processing circuitry determines at decision step 804 that the condition is met (the “Yes” path), indicating, for example, that there is too much collected payload that is not yet launched, the method breaks the collection loop and advances to step 806. At step 806, the processing circuitry commands the first robot which is operating in the dynamic state (which permits both collecting and launching) to temporarily (e.g., for a predetermined configurable duration) transition to exclusively or primarily launching. Specifically, the robots either utilize their object intake mechanisms or facilitate the human operator to load objects to its receptacles and then they utilize their mobility systems to navigate to optimized throwing positions and utilize their articulable arms to project the collected balls toward the specified goal location. The robots continue to perform this coordinated launching sequence until a subsequent condition is met (e.g., the payload is fully depleted, another threshold condition is met, or a secondary operational timer expires).

An illustrative example of the special handling process of FIG. 8 is as follows. In an example scenario instance in which the total objects collected for the robot team is 8 and the total objects projected (launched) by the team is 5, the ratio (8/5=1.6) of total objects collected over the total objects launched is above a configurable launch threshold (ratio_threshold_launch) 1.25. This indicates far too many objects have been collected that have not been launched. In this example instance, the first robot that is operating in the dynamic mode may be temporarily transitioned (e.g., for a configurable duration) to assist in projecting objects.

FIG. 9 is a flowchart illustrating an exemplary method 900 for dynamically transitioning a robot in a robot team operating in the dynamic state in the collaboration mode to a collaborative launching phase based on a threshold condition, according to some embodiments of this disclosure. Method 900 provides a control loop to improve the balance between the number of objects collected and the number of object launched for the robot team, optimizing the flow of resources to the loading zone to be loaded to the robots' receptables either by their robotic intake mechanisms or a human operator.

The method 900 begins at step 902, wherein a first robot (e.g., Robot 1) operates in the collaboration mode and collects objects (e.g., balls) within the operational arena. In this context, “collecting” may comprise utilizing the robot's mobility system and manipulator assembly to gather, sweep, or temporarily stage a plurality of scattered objects into a localized cluster. While the first robot performs this initial collection, the second robot may be occupied with projecting objects to the goal or with defensive tasks or positioned strategically elsewhere in the arena. For example, the second robot, which is also in the collaboration mode, is in the throw state.

As the first robot continuously collects and stages the objects, the method advances to decision step 904. At step 904, the processing circuitry evaluates a dynamic threshold condition, designated as the collection threshold (ratio_threshold_collection) condition. This evaluation may involve determining whether the ratio of collected objects to projected objects meets (is less than or equal to) a predetermined value. The satisfying of the collection threshold indicates that too few objects have been collected by the robot team. This may lead to the consequence that the team is starved of objects to launch.

If the processing circuitry determines at decision step 904 that the ratio_threshold_collection condition is not met (e.g., the collection ratio is exceeded, thus indicating that the collected objects is higher than minimum required), the method follows the “No” path. The system loops back to step 902, enabling the first robot to continue actively collecting and staging objects in the operational arena.

If the processing circuitry determines at decision step 904 that the condition is met (e.g., the collection ratio is not exceeded, thus indicating that the collected objects is lower than minimum required, thus indicating that the collected objects is not yet optimal and further gathering is required), the method follows the “Yes” path and advances to step 906. At step 906, the collaboration algorithm commands the first robot to transition to exclusively collecting. This exclusive collecting by the first robot while operating in collaboration mode may continue, for example, for a predetermined time period, the loading zone reaches maximum capacity, and/or until it is determined that a sufficient inventory of objects is collected.

An illustrative example of the special handling process of FIG. 9 is as follows. In an example scenario instance in which the total objects collected by the first robot is 6 and the total objects projected (launched) by the first robot is 5, the ratio (6/5=1.2) of total objects collected over the total objects launched is less than a configurable collection threshold (ratio_threshold_collection) 1.25. In this example instance, the first robot that is operating in the collaboration mode may be temporarily configured (e.g., for a configurable duration) to exclusively collect objects.

In the above description, embodiments of a robot and a robot team were described in relation to a particular game. However, embodiments of this disclosure are not limited to the described game, the described robot teams, or the described structure of robots. In the described embodiments, the transitions between operating modes and/or states were based on points. However, in some embodiments, such transitions may also be based on physical characteristics of the robots, such as, for example, power availability (e.g., relative power availability, power requirements of tasks to be performed), depleted functionalities (e.g., speed, mobility and/or agility, articulating arm capabilities, etc.), relative positioning in the arena, etc. Some embodiments may be applicable to other games in which a robot can operate in either an independent mode or a dynamic mode in relation to a team. Some embodiments may be applicable to tasks other than games, for example, tasks such as stacking items in a warehouse or grocery store, constructing a wall or other structure, etc.

Although various embodiments have been shown and described in detail, the claims are not limited to any particular embodiment or example. For example, respective features described in various embodiments may be combined to form further embodiments in accordance with the present disclosure.

1. A robotic system, comprising: a first robot assigned to a team, the first robot comprising:
a mobility system including a first motor and a plurality of wheels;
an articulable arm configured to grasp and project objects toward a specified goal location;
a power source;
a memory storing a point-allocation system, a desired sequence of objects, and a collaboration algorithm; and
processing circuitry operatively coupled to the memory, the mobility system, the articulable arm, and the power source, the processing circuitry configured to:
track a number of objects projected by the articulable arm toward the specified goal location;
determine a color associated with each of the projected objects;
calculate a score based on the point-allocation system corresponding to the tracked number and the determined color of the projected objects;
execute the collaboration algorithm to evaluate the tracked number and the determined color of the projected objects against the desired sequence of objects; and
dynamically switch the first robot between a non-collaboration mode and a collaboration mode with at least a second robot of the team based on the evaluation.

2. The robotic system of claim 1, wherein the processing circuitry, while operating the first robot in the collaboration mode, is further configured to:
transmit a communication signal to the second robot, the communication signal comprising trajectory data of the articulable arm and a target location for a subsequent object in the desired sequence.

3. The robotic system of claim 1, wherein the point-allocation system assigns a first point value to a first color and a second point value to a second color, and wherein a threshold condition of the desired sequence comprises the score falling below a predetermined threshold within a specified time interval.

4. The robotic system of claim 1, wherein the first robot further comprises an optical sensor disposed on the articulable arm, the optical sensor configured to capture image data of the objects, and wherein the processing circuitry determines the color associated with each of the projected objects based on the captured image data.

5. A method for coordinating robots, the method comprising:
operating a first robot of a robot team in a non-collaboration mode, the first robot comprising processing circuitry, a mobility system, and an articulable arm;
projecting, via the articulable arm, one or more objects toward a specified goal location;
tracking, by the processing circuitry, a number of the projected objects and a color associated with each of the projected objects;
evaluating, by the processing circuitry, the tracked number and the color of the projected objects against a desired sequence of objects; and
dynamically switching the first robot from the non-collaboration mode to a collaboration mode with a second robot of the robot team based on the evaluation satisfying a threshold condition of the desired sequence.

6. The method of claim 5, wherein the step of evaluating the tracked number and the color of the projected objects against the desired sequence comprises:
determining that a requisite number of objects of a specific color have been successfully projected into the specified goal location; and
triggering the collaboration mode to instruct the second robot to navigate to a defensive position adjacent to the specified goal location.

7. The method of claim 5, wherein dynamically switching the first robot to the collaboration mode further comprises:
halting, by the processing circuitry of the first robot, projection of objects having a first color; and
transmitting an instruction to the second robot to initiate projection of objects having the first color toward the specified goal location.

8. The method of claim 5, wherein the method further, before said operating a first robot of the robot team in the non-collaboration mode, comprises:
calculating a collaboration ratio for the first robot based on a number of historical operational periods concluded in the collaboration mode relative to a number of historical operational periods concluded in the non-collaboration mode;
calculating a second ratio for the second robot based on a number of historical operational periods concluded in the collaboration mode relative to a number of historical operational periods concluded in the non-collaboration mode;
calculating a product of the collaboration ratio of the first robot and the collaboration ratio of the second robot; and
initiating the robot team in the non-collaboration mode in response to determining the calculated product is less than a predetermined collaboration mode threshold.

9. The method of claim 5, wherein the method further comprises an initialization routine executed by the processing circuitry prior to initiating the collaboration mode, the initialization routine comprising:
calculating a collaboration ratio for the first robot based on a number of historical operational periods concluded in the collaboration mode relative to a number of historical operational periods concluded in the non-collaboration mode;
calculating a second ratio for the second robot based on a number of historical operational periods concluded in the collaboration mode relative to a number of historical operational periods concluded in the non-collaboration mode;
calculating a product of the collaboration ratio of the first robot and the collaboration ratio of the second robot; and
initiating the robot team in the collaboration mode in response to determining the calculated product exceeds a predetermined threshold.

10. The method of claim 5, wherein operating the robot team in the collaboration mode comprises assigning the first robot to a dynamic state and assigning the second robot to a throw state, wherein the dynamic state comprises both translating objects to a loading zone and projecting objects toward the specified goal location, and the throw state comprises exclusively projecting objects toward the specified goal location, the method further comprising:
retrieving a first historical projection accuracy metric for the first robot and a second historical projection accuracy metric for the second robot;
comparing the first historical projection accuracy metric to the second historical projection accuracy metric; and
assigning the second robot to the throw state and the first robot to the dynamic state in response to determining the second historical projection accuracy metric is greater than the first historical projection accuracy metric.

11. The method of claim 5, wherein operating the robot team in the collaboration mode comprises:
running a collaboration duration timer;
monitoring a total points and a collaboration swap threshold value, wherein the collaboration swap threshold is dynamically incremented in accordance with the collaboration duration timer;
evaluating, based on the monitoring, a collaboration state swap condition;
swapping the first robot from a dynamic state to a throw state or from the throw state to the dynamic state; and
signaling the second robot to swap its state.

12. The method of claim 11, wherein the collaboration duration timer is countdown timer, and the method further comprises:
incrementing the collaboration swap threshold in accordance with a decrementing of the countdown timer.

13. The method of claim 11, further comprising, after the swapping, stopping the collaboration duration timer and the monitoring.

14. The method of claim 11, further comprising:
dynamically changing the first robot from the collaboration mode to a swap collaboration mode.

15. The method of claim 11, wherein the evaluating, by the processing circuitry, the tracked number and the color of the projected objects against a desired sequence of objects comprises:
when a number of objects projected by the robot team is equal to or exceeds an object threshold, determining accumulated points for the robot team;
if the accumulated points is less than a points threshold and the first robot is operating in the collaboration mode, swapping the first robot from the dynamic state to the throw state or from the throw state to the dynamic state.

16. The method of claim 11, wherein the evaluating, by the processing circuitry, the tracked number and the color of the projected objects against a desired sequence of objects comprises:
determining a k-factor based on the desired sequence of objects;
if a first ratio of collected objects having a first color to the collected objects having a second color is less than or equal to the k-factor, collect objects of the first color, otherwise collect objects of the second color.

17. A non-transitory computer readable storage medium having stored therein program instructions that, when executed by a processing circuitry of a first robot of a robot team comprising at least the first robot and a second robot, causes the first robot to perform operations comprising:
operating the first robot in a non-collaboration mode, the first robot comprising processing circuitry, a mobility system, and an articulable arm;
projecting, via the articulable arm, one or more objects toward a specified goal location;
tracking, by the processing circuitry, a number of the projected objects and a color associated with each of the projected objects;
evaluating, by the processing circuitry, the tracked number and the color of the projected objects against a desired sequence of objects; and
dynamically switching the first robot from the non-collaboration mode to a collaboration mode with the second robot of the robot team based on the evaluation satisfying a threshold condition of the desired sequence.
